(19) United States
(12) Patent Application Publication
(10) Pub. No.: US 2006/0053286 A1
(43) Pub. Date: Mar. 9, 2006

(54) Unique identifier label

(76) Inventor: Phillip S. Schaengold, Arlington, VA (US)

Correspondence Address: BOND, SCHOENECK & KING, PLLC, 10 BROWN ROAD, SUITE 201, ITHACA, NY, 14850-1248, US

(21) Appl. No.: 11/222,389

(22) Filed: Sep. 8, 2005

Related U.S. Application Data
(60) Provisional application No. 60/522,263, filed on Sep. 8, 2004.

(51) Int. Cl. H04L 9/00

(52) U.S. Cl. 713/166

(57) ABSTRACT

The present invention is directed to a label for authenticating and tracking an object. The label includes an electronic security layer including an antenna configured to receive an interrogation signal propagating within a predetermined distance from the label and transmit a response message. A programmable circuit is coupled to the antenna. The programmable circuit is configured to store authentication data and tracking data, retrieve the authentication data and the tracking data in response to the interrogation signal, and formulate the response message. The response message includes at least a portion of the authentication data and the tracking data. An optical indicia layer is affixed to a first side of the electronic security layer. The optical indicia layer has disposed thereon optically encoded indicia corresponding to at least a portion of the authentication data and at least a portion of tracking data stored in the electronic security layer. An adhesive layer is disposed on a second side of the electronic security layer, the adhesive layer being configured to affix the label to the object.

### CROSS-REFERENCE TO RELATED APPLICATIONS

This application claims priority to U.S. Provisional Patent Application Ser. No. 60/522,263 filed on Sep. 8, 2004, the content of which is relied upon and incorporated herein by reference in its entirety, and the benefit of priority under 35 U.S.C. § 119(e) is hereby claimed.

### BACKGROUND OF THE INVENTION

1. Field of the Invention

The present invention relates generally to security systems, and particularly to electro-optical security systems.

2. Technical Background

Producers of manufactured goods are known to spend vast sums to create brands that will be recognized and trusted by consumers. Brands are often communicated to the consumer by advertising campaigns that associate a graphical brand mark with a particular producer. A brand mark typically include symbols, text, and color schemes associated with the producer. When a given product obtains a certain status with the public; or reaches a certain sales volume, counterfeiters are tempted to “pass off” inferior and dangerous counterfeit products in the market place. In response, legitimate manufacturers have attempted to make their products more secure with various types of labeling mechanisms.

The labeling and packaging problem became more serious in 1982 when capsules containing a well-known pain relieving drug were laced with cyanide. The manufacturer recalled millions of bottles of the popular pain reliever at a staggering cost. The manufacturer also immediately responded by packaging the product in tamper-proof containers. As a result, cap seals and heat-shrink sleeves are standard bottle features.

However, the aforementioned solution is inadequate in the face of product diversion and other forms of product counterfeiting. Pharmaceutical companies are finding that some of their legitimate product is being stolen and sold in other markets. According to one estimate, nearly 70% of the pharmaceutical products sold in developing countries are counterfeit. On the other hand, approximately 10% of the pharmaceuticals imported into the United States may be substandard, counterfeit, or lack FDA approval.

Accordingly, there is a critical need for a system that better protects the nation's, and indeed the world's, drug supply. There is a further need for a system for authenticating, tracking and tracing products to provide a greater level of security by protecting the product, packaging, and movement of the product as it travels through the drug supply chain.

### SUMMARY OF THE INVENTION

The present invention addresses the needs described above. The present invention is directed to a system for authenticating, tracking and tracing products to provide a greater level of security by protecting the product, packaging, and movement of the product as it travels through the supply chain. The present invention may be applied to any industry wherein security is an issue.

One aspect of the present invention is directed to a label for authenticating and tracking an object. The label includes an electronic security layer including an antenna configured to receive an interrogation signal propagating within a predetermined distance from the label and transmit a response message. A programmable circuit is coupled to the antenna. The programmable circuit is configured to store authentication data and tracking data, retrieve the authentication data and the tracking data in response to the interrogation signal, and formulate the response message. The response message includes at least a portion of the authentication data and the tracking data. An optical indicia layer is affixed to a first side of the electronic security layer. The optical indicia layer has disposed thereon optically encoded indicia corresponding to at least a portion of the authentication data and at least a portion of tracking data stored in the electronic security layer. An adhesive layer is disposed on a second side of the electronic security layer, the adhesive layer being configured to affix the label to the object.

In another aspect, the present invention is directed to a system for authenticating and tracking a plurality of objects in commerce. The system includes a label affixed to each of the plurality of objects. The label includes an electronic security layer configured to receive an interrogation signal propagating within a predetermined distance from the label. The electronic security layer is configured to store authentication data and tracking data, retrieve the authentication data and the tracking data in response to the interrogation signal, and transmit a response message including at least a portion of the authentication data and the tracking data. The label also includes an optical indicia layer affixed the electronic security layer. The optical indicia layer has disposed thereon optically encoded indicia corresponding to at least a portion of the authentication data stored in the electronic security layer. An interrogation device is configured to transmit the interrogation signal and receive the response message. The interrogation device also is configured to recover the authentication data and the tracking data from the response message. A computer is coupled to the interrogation device and configured to generate indication data based on the authentication data. The indication data indicates whether the label is an authentic label.

In another aspect, the present invention is directed to a method for authenticating and tracking a plurality of objects in commerce. The method includes affixing a label to each of the plurality of objects. The label includes an electronic security layer configured to receive an interrogation signal propagating within a predetermined distance from the label. The electronic security layer is configured to store authentication data and tracking data, retrieve the authentication data and the tracking data in response to the interrogation signal, and transmit a response message including at least a portion of the authentication data and the tracking data. The label also includes an optical indicia layer affixed the electronic security layer. The optical indicia layer having disposed thereon optically encoded indicia corresponding to at least a portion of the authentication data stored in the electronic security layer. The method also includes transmitting the interrogation signal. Indication data is generated based on whether a response is received from the label. The indication data indicates that a label is inauthentic if no response message is received. The indication data is also based on the authentication data provided in the response message, whereby the indication data indicates whether the label is an authentic label.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a perspective view of a smart label in accordance with one embodiment of the present invention;

FIG. 2 is a block diagram of the label depicted in FIG. 1;

FIG. 3 is a block diagram of an interrogation mechanism in accordance with an embodiment of the present invention;

FIG. 4 is a block diagram of a networked interrogate, track, and trace system in accordance with yet another embodiment of the present invention; and

FIG. 5 is a flow chart illustrating a method for authenticating and tracking products that have entered the stream of commerce in accordance with the present invention.

### DETAILED DESCRIPTION

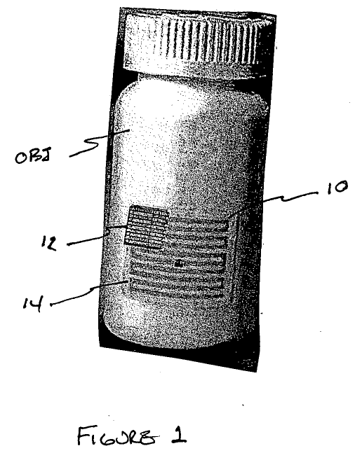

Reference will now be made in detail to the present embodiments of the invention, examples of which are illustrated in the accompanying drawings. Wherever possible, the same reference numbers will be used throughout the drawings to refer to the same or like parts. An exemplary embodiment of the label of the present invention is shown in FIG. 1, and is designated generally throughout by reference numeral 10.

As embodied herein, and depicted FIG. 1, a perspective view of a smart label 10 in accordance with one embodiment of the present invention is disclosed. FIG. 1 illustrates how smart label 10 is employed in the market place. Label 10 includes an adhesive backing (not shown) which is configured to adhere to the object OBJ. Label 10 includes an electronic security layer (ESL) 14. As will be described in greater detail below, the ESL 14 includes an antenna configured to receive an interrogation signal propagating within a predetermined distance from the label. The antenna is also configured to transmit a response message. ESL 14 also includes a programmable circuit coupled to the antenna. The programmable circuit is configured to store authentication data and tracking data, retrieve the authentication data and the tracking data in response to the interrogation signal, and formulate a response message. Of course, the response message includes at least a portion of the authentication data and the tracking data stored therein, depending on the nature of the interrogation signal transmitted by the interrogator (not shown in FIG. 1).

Label 10 also includes an optical indicia layer (OIL) 12 affixed to a first side of the ESL 14. The optical indicia layer 12 has optically encoded indicia disposed thereon. The optically encoded indicia corresponds to at least a portion of the authentication data and at least a portion of the tracking data stored in the ESL 14.

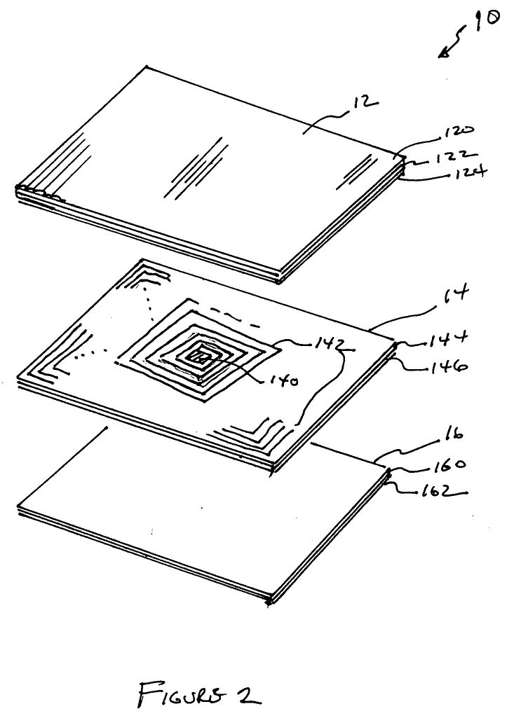

As embodied herein and depicted in FIG. 2, a block diagram of the label 10 depicted in FIG. 1 is disclosed. As alluded to above, label 10 includes an optical indicia layer (OIL) 12, an electronic security layer (ESL) 14, and adhesive layer 16. Adhesive layer 16 includes an adhesive 160 that is affixed to a surface 146 of ESL 14. A backing material 162 is stripped from the adhesive layer 160, allowing label 10 to be applied to the object. It will be apparent to those of ordinary skill in the pertinent art that adhesive layer 18 may be of any suitable type of adhesives commonly employed to attach labels in a non-removable manner. In another example, an ultraviolet curable pressure sensitive adhesive may also be employed. Adhesive layer 16 provides label 10 with an adhesive surface that enables the finished label 10 to adhere to the object OBJ.

ESL 14 includes a non-conductive dielectric substrate layer 146 that includes a sheet of an electrically non-conductive material on which the ESL circuitry layer 144 is formed. It will be apparent to those of ordinary skill in the pertinent art that modifications and variations may be made to substrate layer 146 of the present invention depending on cost, capability, and manufacturing techniques. For example, ESL circuitry 144 may be disposed on layer 146 by patterning techniques commonly known in the art. On the other hand, ESL circuitry may be implemented as a discrete layer that is affixed to layer 146. As such, substrate 146 may be. Of course, those of ordinary skill in the art will recognize that layer 146 may be formed from materials that include, but are not limited to, high Tg polycarbonate, poly(ethylene terephthalate), polyarylate, polysulfone, a norbornene copolymer, poly phenylsulfone, polyetherimide, polyethylenenaphthalate (PEN), polyethersulfone (PES), polycarbonate (PC), a phenolic resin, polyester, polyimide, polyetherester, polyetheramide, cellulose acetate, aliphatic polyurethanes, polyacrylonitrile, polytrifluoroethylenes, polyvinylidene fluorides, HDPEs, poly(methyl methacrylates), a cyclic or acyclic polyolefin, or paper.

As shown in FIG. 2, circuit 144 includes antenna 142 and circuitry 140. The antenna 142 is made from a conductive material, such as a metallic material. The terms “conductive” and “nonconductive,” as used herein, refer to electrical conductivity. Antenna 142 may be formed from a conductive ink that is printed or otherwise deposited on the inlay substrate 144. Alternatively, the antenna 142 may be formed from metal deposited on the substrate 144 by any of a variety of suitable deposition methods, such as vapor deposition. As a further alternative, the antenna 142 may be part of a web of antenna material that is adhered to the substrate by suitable means, for example, by use of a suitable adhesive in a lamination process. Antenna 142 may be disposed in the square pattern depicted, a spiral pattern, a web of antennas, or in any suitable arrangement by way of aluminum, copper, gold, nickel, bronze, brass, silver-based conductive epoxies, certain graphite materials, or any other suitable electrically conductive material. Other thin conductive material such as etched or hot-stamped metal foil, conductive ink, sputtered metal, and/or etc. may be employed as well. Accordingly, antenna 142 may be implemented using polymer and/or organic materials that are disposed on a substrate by way of ink application or screening techniques (silk screening, for example). Finally, antennas 142 may be employed using lithography or electroplating techniques.

Those of ordinary skill in the art will understand that antenna 142 may be disposed on substrate 146 using any suitable geometric shape and conductive pattern, such as a square, rectangular, circular or spiral patterns as are well known for radio frequency devices. As those of ordinary skill in the art will appreciate, the patterns may be of an infinite number and are not restricted to square, rectangular, spiral, or any type of pattern. The conductive patterns, no matter what the shape employed, may be patterned by some suitable subtractive process, such as etching. The electronic circuitry for the radio frequency transponder is fabricated into an integrated circuit 140 which is attached to the surface of layer 146 and electrically connected to the antenna 142.

Antenna 140 and a portion of circuitry 140 may be configured as an LC network comprising inductive antenna coil 142 and one or more capacitors disposed in circuit 140. In one embodiment, interrogator 20 transmits at a first frequency corresponding to the resonant frequency of the LC network. The LC network derives power from the EM field which is used to energize the integrated circuit (IC) within circuitry 140. In another embodiment a small battery may be employed to power circuit 140. Those of ordinary skill in the art will recognize that a battery powered label will not have the flatness associated with a passive RF label. On the other hand, a battery powered device enables a circuit 140 with more capabilities, including greater processing and memory storage capabilities.

An interrogation transaction with ESL 14 begins when the object OBJ is disposed within the electromagnetic (EM) field created by interrogator 20. The interrogation pulse propagates in antenna 142 and the IC responds by reading a value from memory. The value may include all, or a portion of, the authentication and tracking data programmed into the memory. In one embodiment, different interrogation signals are employed to access different registers in the memory. At this point, circuit 140 may switch between capacitors to thereby reply via a second RF frequency. The signals are modulated in order that encoded data may be transferred between reader/interrogator 20 and label 10. The modulation scheme may be pulse-width, phase-amplitude or any suitable type of modulation. Authentication data may include a product identifier code, a product manufacturer code, and/or encrypted authentication data. Tracking data may include a manufacturing lot number, product origination data, product delivery data, and/or product delivery routing data.

The optical indicia layer (OIL) 12 may include any suitable type of optical indicia and/or optical presentation techniques. In one embodiment OIL 12 includes both visible unique identifiers and encoded unique identifiers having object related identification data. The optical layer 12 may include pictorial data, alpha-numeric data, bar code indicia, printed data, embedded code, and/or digitally generated data. Layer 12 may be implemented using holograms, holograms having visually undetectable data embedded within the hologram, lenticular lens layers, and/or three-dimensional optical images. Optical data may be implemented by etching, embossing, and/or laser stamping data on an appropriate substrate. The present invention may employ linear, two-dimensional, and/or three-dimensional bar codes.

For example, a hologram may be adhered to, laminated on, or otherwise formed on the upper surface of ESL 14. In one embodiment, the hologram comprises at least one non-metallic, reflective film 124 which covers the upper surface of ESL 14. The non-metallic film reflects light away from the label 10. Reference is made to U.S. Pat. No. 5,448,404, which is incorporated herein by reference as though fully set forth in its entirety, for a more detailed explanation of the non-metallic reflective film. This exemplary non-metallic film is a formable multiple layer reflective polymeric body which has a substantially uniform broad bandwidth reflectance over substantially the entire range of the visible spectrum to provide a substantially uniform reflective appearance. The non-metallic, reflective film includes at least first and second diverse polymeric materials and has a sufficient number of alternating layers of the first and second polymeric materials, such that at least 40% of visible light incident on the film is reflected. A substantial majority of the individual layers of the film have optical thicknesses in the range where the sum of the optical thicknesses in a repeating unit of the polymeric materials is greater than about 190 nm, and the first and second polymeric materials have refractive indices which differ from each other by at least about 0.03. Another suitable multi-layer polymeric film has an outside layer of polyethylenenaphthalate (PEN). Both of these films have a high specular reflectance so as to resemble a highly reflective metal layer.

Abutting the non-metallic, reflective film is a generally transparent layer 122 containing a transparent holographic image. Because the reflective surface provided by film 144 is non-metallic, it does not interfere with the tuning of the transponder circuitry. This avoids the need to space the hologram significant distance from that circuitry, thereby enabling the entire label 10 to have a relatively thin profile.

A reflective hologram provides a security function in a number of ways. First, if someone attempts to remove label 10 from one object and apply the label to another object, the holographic image may be adversely affected in a visible manner. Second, a counterfeiter may not realize that a given label 10 includes encoded data invisible to the naked eye. As such, the hologram implementation makes counterfeiting the label more difficult. Further, a hologram with a non-metallic reflector provides a deterrent to unauthorized use of the label 10 without affecting the operation of the ESL 14. The holographic layer 12 of the present invention may include customized tamper-apparent break patterns, black-light verification systems, and machine-readable embedded code. The holographic layer 12 of the present invention may also incorporate micro-imagery, bar codes, digital watermarks, and hidden images that are difficult, if not impossible, for counterfeiters to replicate. The data embedded and/or encoded in the hologram is well suited for tracking the product/object OBJ throughout distribution.

Optical layer 12 may also incorporate a lenticular lens sheet depicted in FIG. 2 as layer 120. Note that the invention is not limited to using any specific inks or equipment to print any of the features, including the interlaced images described herein. Inks such as ultraviolet (UV), infrared (IR), etc. are usable in at least some embodiments of the invention, as well as inks that are toner-based and/or UV-curable. Further, in at least some embodiments of the invention, the equipment and/or printing presses used can include offset, digital variable offset, inkjet, laser toner-based, etc. A first security image(s) may be printed using a visible image and a second security image may be printed using a non-visible ink (e.g., UV or IR ink) or an optically variable ink. Many different possible combinations are contemplated to be within the spirit and scope of the invention.

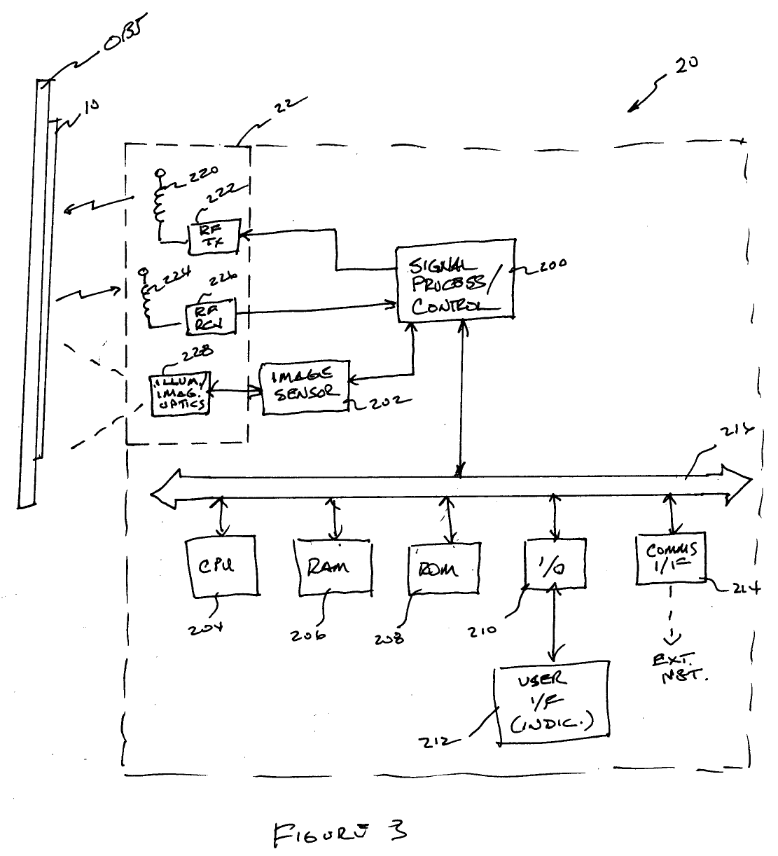

As embodied herein and depicted in FIG. 3, a block diagram of an interrogation mechanism in accordance with an embodiment of the present invention is disclosed. FIG. 3 shows interrogation device 20 coupled to an interrogation transponder 22. Transponder 22 includes a plurality of RF transponders, each including transmit antenna 220 coupled to transmitter 222, and receive antenna 224 coupled to RF receiver 226. Transmitter 222 and receiver 226 are coupled to a processor module 200. Interrogator 228 may also include illumination and imaging optics 228. Optics 228 are coupled to image sensor 202. Processor module 200 is coupled to buss system 216. Interrogation electronics 20 also includes CPU 204, RAM 206, ROM 208, I/O card 210, and communications interface 214. The I/O card supports a user interface 212 which, in part, provides the user with an alarm indicator if the object OBJ is deemed to be invalid.

Imaging optics 228 focuses the illumination light reflected from the object onto imager 202. Image sensor 202 may provide color or B/W imaging data to processor 200. Imager 202 may be configured to generate color analog image signals using an imaging array color filter. The array color filter pattern may be configured as a Bayer-pattern. The analog color imaging data is converted into a digital format using an internal A/D converter which also functions as a quantizer device. Those skilled in the art will understand that an 8-bit system provides 256 brightness levels, whereas a 12-bit converter provides over 4,000 brightness levels. Digital color imaging data is transmitted from imager 202 to data processor 200 and CPU 204.

Imaging/illumination optics 228 may be of any suitable type depending on the size, resolution, and complexity of optical layer 12 and the encoded data, if any, disposed thereon. Imaging/illumination optics may include one or more lenses, diffusers, wedges, reflectors or a combination of these elements. Those skilled in the art will understand that the imaging lenses may be configured to project a magnified image of embedded coding to image sensor 202.

Color imager 202 may be of any suitable type, but there is shown by way of example, a CMOS color imager having an 640×480 pixel resolution. It will be apparent to those of ordinary skill in the pertinent art that modifications and variations can be made to color imager 34 of the present invention depending on cost and the resolution required by interrogator 20. In another embodiment, color imager 202 has 800×600 pixels. A typical VGA resolution of 640×480 pixels is adequate for displaying color images on a LCD or a computer monitor. In one mega pixel embodiment, color imager 202 has 1156×864 pixels (almost 1-million pixels). In yet another embodiment, color imager 202 includes 1536×1024 pixels. One of ordinary skill in the art will recognize that as the resolution of imager 202 increases, so will the cost. In another embodiment, color imager 202 is implemented by scanning a linear CCD array. In other embodiments, color imager 202 is implemented using an area CCD solid state image sensor.

CPU 204 may be implemented using an off-the-shelf VLSI integrated circuit (IC) microprocessor. CPU 204 is programmed to provide the high-level control of interrogator 20, including any user-interface menu operations, command and data received from I/O card 210, data written to display 212, and operating system functions. CPU 204 may also be programmed to process and decode ESL 14 and OIL 12 data stored in RAM 206 in accordance with the programming instructions stored in ROM 208.

Processor 200 may be implemented using any suitable device such as a digital signal processor, a programmable logic array device, an application specific integrated circuit (ASIC), and/or a field programmable gate array (FPGA) device. Processor 200 is configured to control the interrogation/response process, as well as the storage of RF response and/or image data. Processor 200 is configured to perform various timing and control functions including control of light sources and control of imager 202. It will be apparent to those of ordinary skill in the pertinent art that modifications and variations can be made to processor 200 of the present invention depending on the cost, availability, and performance of off-the-shelf microprocessors, and the type of imager used. In one embodiment, CPU and processor 200 may be combined and implemented using a single RISC processor, or a single DSP processor.

RAM is used to store data and instructions for execution by the processor. RAM may also be used for storing temporary variables or other intermediate information during execution of instructions by the CPU. Those skilled in the art will also understand that ROM may be implemented using PROM, EPROM, E²PROM, FLASH-EPROM and/or any other suitable static storage device. Storage devices such as a magnetic disks or optical disks may also be included.

The communication interface 214 may typically be of any suitable type including a local area network (LAN) card (e.g. for Ethernet™ or an Asynchronous Transfer Model (ATM) network) configured to provide a data communication connection to a compatible LAN. As another example, the communication interface may be a digital subscriber line (DSL) card or modem, an integrated services digital network (ISDN) card, a cable modem, a telephone modem, or any other communication interface to provide a data communication connection to a corresponding type of communication line. Wireless links may also be implemented. In any such implementation, the communication interface transmits and receives electrical, electromagnetic, or optical data signals. The communication interface may also include peripheral interface devices, such as a Universal Serial Bus (USB) interface, a PCMCIA (Personal Computer Memory Card International Association) interface, etc. Although the aforementioned description refers to a single communication interface, multiple communication interfaces may be employed herein.

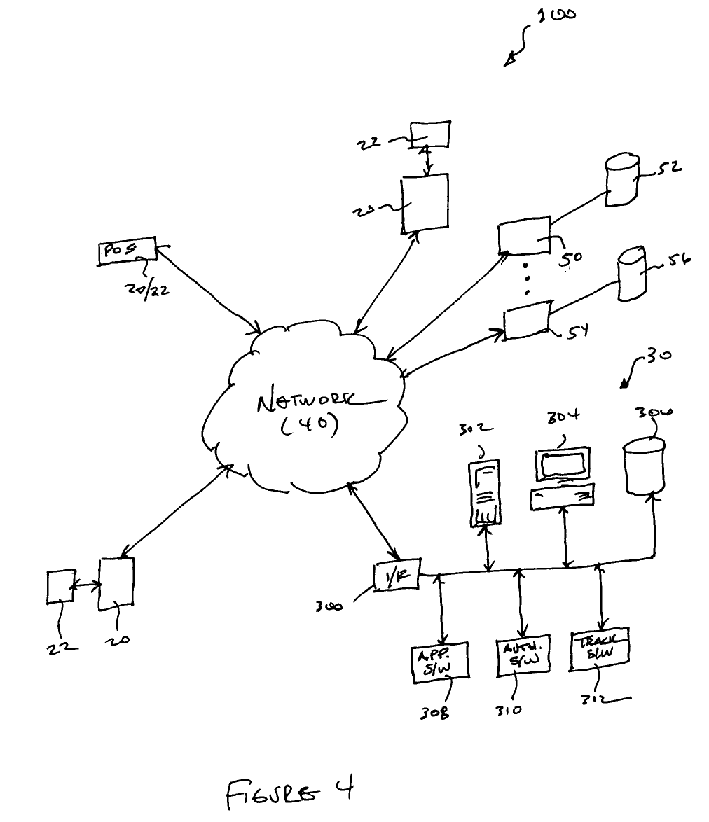

Referring to FIG. 4, a block diagram of a networked interrogate, track, and trace system 100 in accordance with yet another embodiment of the present invention is disclosed. System 100 may include a plurality of interrogation systems 20 disposed either locally or over a wide area depending on the implementation. The present invention also contemplates either a localized processing system wherein authentication and tracking is performed by a single unit 20, or a distributed system wherein a simple point-of-service terminal 20/22 communicates with service center 30 via network 40. Of course, those of ordinary skill in the art will understand that processing functions may be distributed between device 20 and center 30 as needed or required by any given implementation. Those of ordinary skill in the art will understand that while interrogation device 20, server 302, or workstation 304 are accessing database 306, they may also be accessing any number of external databases (52 . . . 56), such as CVS or AmeriSource, with a single query. Of course, these are non-limiting examples of such databases. These same system components may also access XML or other web based services represented by web sites (50 . . . 54).

Network servicing center 30 is coupled to network 40 via interface 300. Center 30 also includes one or more servers 302, workstation(s) 304, database(s) 306, application software modules 308, authentication module 310, as well as tracking module 312. Center 30 accommodates any number of useful applications programs 308.

Those skilled in the art will also understand that network 40 may be a local area network (LAN), a wide area network (WAN), a private network, a public network, or any combination thereof. As such, network 40 may employ the public switched telephony network (PSTN), a packet-switched network such as an Internet backbone, a wireless telephony system, and/or any combination thereof.

Those skilled in the art will also understand that transmission media employed between any of the units depicted in FIG. 2 may include coaxial cables, computer backplane interfaces, copper wire and/or fiber optic transmission media. Further, transmission media may be implemented using acoustic, optical, or other electromagnetic waves, such as those generated by radio frequency (RF) and infrared data communications components.

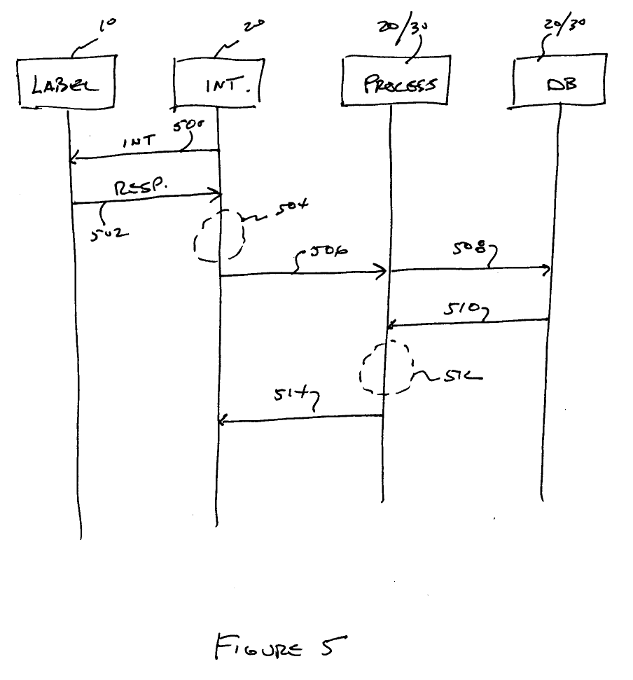

Referring to FIG. 5, a flow chart illustrating a method for authenticating and tracking products in accordance with the present invention is shown. In step 500, interrogator device 20 interrogates label 10. As discussed above, the interrogation may include both an RF interrogation pulse as well as a scanning of the optical layer 12 disposed on label 10. Assuming that label 10 is authentic, ESL 14 provides a response in step 502. In step 504, interrogator 20 may decode any image data and further process the data provided in the RF response. In one embodiment, interrogator 20 is configured to perform all of the authentication and tracking duties by way of its internal processing capabilities. In another embodiment, interrogator 20 transmits a data package to a computer in center 30. In step 508, the processor(s) (i.e., processors 200/204, server computer 302, or workstation 304) retrieve(s) pre-stored authentication data from memory (206,208) or database 306. In step 510, the pre-stored data is compared with the response data to determine whether label 10 is authentic. In step 514, indication data is transmitted to the interrogator and an indication signal is provided to the user. The indication signal may be presented on a workstation display, or it may be in the form of a visual indicator, such as a blinking light or a colored (red/green) light. Audible indicators may be employed as well.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A label for authenticating and tracking an object, the label comprising:
an electronic security layer including an antenna configured to receive an interrogation signal propagating within a predetermined distance from the label and transmit a response message, a programmable circuit coupled to the antenna, the programmable circuit being configured to store authentication data and tracking data, retrieve the authentication data and the tracking data in response to the interrogation signal, and formulate the response message, the response message including at least a portion of the authentication data and the tracking data;
an optical indicia layer affixed to a first side of the electronic security layer, the optical indicia layer having disposed thereon optically encoded indicia corresponding to at least a portion of the authentication data and at least a portion of tracking data stored in the electronic security layer; and
an adhesive layer disposed on a second side of the electronic security layer, the adhesive layer being configured to affix the label to the object.

2. The label of claim 1, further comprising a circuit component coupled to the programmable circuit, the circuit component being configured to provide power to the programmable circuit.

3. The label of claim 2, wherein the circuit component and the antenna form a passive resonant circuit configured to derive power from the interrogation signal.

4. The label of claim 3, wherein the interrogation signal is characterized by a radio frequency, the radio frequency being the resonant frequency of the circuit component.

5. The label of claim 4, wherein the response message is characterized by a second radio frequency different than the resonant frequency.

6. The label of claim 2, wherein the circuit component includes a battery.

7. The label of claim 1, wherein the authentication data includes one or more of an object identifier code, an object manufacturer identifier code, and/or encryption data.

8. The label of claim 1, wherein the tracking data includes one or more of a manufacturing lot number, object origination data, object delivery data, and/or object delivery routing data.

9. The label of claim 1, wherein the optically encoded indicia corresponding to the authentication data and tracking data is selected from a group that includes alpha-numeric data, barcode indicia, printed data, embedded coded data, etched data, embossed data, watermark data, digitally generated data, and/or laser stamped data.

10. The label of claim 1, wherein the optical indicia layer further comprises a lenticular lens layer.

11. The label of claim 10, further comprising a base layer affixed to the lenticular lens layer, the base layer including the optically encoded indicia corresponding to the authentication data and tracking data disposed thereon, the optically encoded indicia being optically readable through the lenticular lens layer.

12. The label of claim 10, wherein all or at least a portion of the optically encoded indicia corresponding to the authentication data and tracking data is embossed or etched into a surface of the lenticular lens layer.

13. A system for authenticating and tracking a plurality of objects in commerce, the system comprising:
a label affixed to each of the plurality of objects, the label including an electronic security layer configured to receive an interrogation signal propagating within a predetermined distance from the label, the electronic security layer being configured to store authentication data and tracking data, retrieve the authentication data and the tracking data in response to the interrogation signal, and transmit a response message including at least a portion of the authentication data and the tracking data, the label also including an optical indicia layer affixed the electronic security layer, the optical indicia layer having disposed thereon optically encoded indicia corresponding to at least a portion of the authentication data stored in the electronic security layer;
an interrogation device configured to transmit the interrogation signal and receive the response message, the interrogation device also being configured to recover the authentication data and the tracking data from the response message;
a computer coupled to the interrogation device and configured to generate indication data based on the authentication data, the indication data indicating whether the label is an authentic label.

14. The system of claim 13, wherein the computer generates the indication data by comparing the authentication data with predetermined authentication data.

15. The system of claim 13, wherein the interrogation device further comprises an optical reader configured to scan the optical indicia layer to thereby recover a data output signal.

16. The system of claim 15, wherein the computer generates the indication data by comparing the data output signal to the authentication data stored in the electronic security layer.

17. The system of claim 15, wherein the computer generates the indication data by comparing the data output signal to the predetermined authentication data.

18. The system of claim 13, further comprising a database coupled to the computer, the database including a plurality of records corresponding to the plurality of objects in commerce, each of the plurality of records uniquely corresponding to one of the plurality of objects in commerce, each of the plurality of records including predetermined authentication data and predetermined tracking data corresponding to an object.

19. The system of claim 13, wherein the interrogation device further comprises a communication interface configured to remotely couple the interrogation device to the computer by of a network.

20. The system of claim 19, wherein the network is a telephony network.

21. The system of claim 20, wherein the telephony network includes a wire line network, a wireless network, or a combination thereof.

22. The system of claim 20, wherein the telephony network includes a circuit switched network, a packet switched network, or a combination thereof.

23. The system of claim 19, wherein the network includes the Internet.

24. The system of claim 19, wherein the network includes a local area network and/or a wide area network.

25. The system of claim 13, further comprising a user interface coupled to the computer, the user interface including an indication device configured to generate a user discernable signal corresponding to the indication data.

26. The system of claim 25, wherein the indication device includes a visual display.

27. The system of claim 25, wherein the indication device includes an audible alarm.

28. The system of claim 13, wherein the computer is configured to generate indication data based on the tracking data.

29. The system of claim 13, wherein the authentication data includes one or more of an object identifier code, an object manufacturer identifier code, and/or encryption data.

30. The system of claim 28, wherein the computer generates the indication data by comparing the tracking data with predetermined tracking data.

31. The system of claim 30, wherein the tracking data includes one or more of a manufacturing lot number, object origination data, object delivery data, and/or object delivery routing data.

32. A method for authenticating and tracking a plurality of objects in commerce, the method comprising:
affixing a label to each of the plurality of objects, the label including an electronic security layer configured to receive an interrogation signal propagating within a predetermined distance from the label, the electronic security layer being configured to store authentication data and tracking data, retrieve the authentication data and the tracking data in response to the interrogation signal, and transmit a response message including at least a portion of the authentication data and the tracking data, the label also including an optical indicia layer affixed the electronic security layer, the optical indicia layer having disposed thereon optically encoded indicia corresponding to at least a portion of the authentication data stored in the electronic security layer;
transmitting the interrogation signal; and
generating indication data based on whether a response is received from the label, the indication data indicates that a label is inauthentic if no response message is received, the indication data being also based on the authentication data provided in the response message, whereby the indication data indicates whether the label is an authentic label.

33. The method of claim 32, further comprising:
receiving the response message;
recovering the authentication data and the tracking data from the response message; and
comparing the authentication data with predetermined authentication data and/or comparing the tracking data with predetermined tracking data.

34. The method of claim 32, further comprising the step of providing an indication signal in accordance with the indication data.
